(19) United States
(12) Patent Application Publication
(10) Pub. No.: US 2025/0200672 A1
(43) Pub. Date: Jun. 19, 2025

(54) ACCOUNTING SYSTEM

(71) Applicant: Semiconductor Energy Laboratory Co., Ltd., Atsugi-shi (JP)

(72) Inventors: Junpei MOMO, Sagamihara (JP); Mitsuru KOJIMA, Atsugi (JP); Hiromi NISHIDO, Atsugi (JP); Motoki NAKASHIMA, Atsugi (JP)

(21) Appl. No.: 18/969,522

(22) Filed: Dec. 5, 2024

(30) Foreign Application Priority Data
Dec. 15, 2023 (JP) 2023-211740

(51) Int. Cl. G06Q 40/12

(52) U.S. Cl. CPC G06Q 40/128

(57) ABSTRACT

An accounting system having a function of automatically linking a paper-based voucher and transaction data is provided. The accounting system includes a reception unit and a processing unit. The reception unit has functions of receiving voucher data and receiving approval or disapproval of a suggestion presented by the processing unit; the processing unit includes a database holding transaction data and has a first function of: obtaining a plurality of pieces of transaction data whose voucher is not registered from the database; collating the plurality of pieces of transaction data with the voucher data; identifying transaction data matching with the voucher data; showing a suggestion to link the voucher data and the transaction data in the reception unit; and registering the link approved in the reception unit in the database; and a second function of extracting additional information included in the voucher data and not included in the transaction data to register the additional information in the transaction data.

### BACKGROUND OF THE INVENTION

### 1. Field of the Invention

One embodiment of the present invention relates to an information processing method, an information processing device, and an information processing system. One embodiment of the present invention relates to an information processing method and an information processing system utilizing a language model. Specifically, one embodiment of the present invention relates to an accounting system utilizing a language model.

Note that one embodiment of the present invention is not limited to the above technical field. Examples of the technical field of one embodiment of the present invention include a semiconductor device, a display apparatus, a light-emitting apparatus, a power storage device, a storage device, an electronic apparatus, a lighting device, an input device (e.g., a touch sensor), an input/output device (e.g., a touch panel), a method for driving any of them, and a method for manufacturing any of them.

### 2. Description of the Related Art

As accounting processing relating to vouchers, input of accounting data, an audit of an accounting report, and the like are given. Accounting software that helps accounting processing of vouchers is becoming popular. However, these operations need to be carried out by checking each voucher even with accounting software because paper-based vouchers are used in many cases. Thus, work efficiency is low, and an input error may occur.

Various types of software have been developed to increase work efficiency and reduce input errors relating to paper-based vouchers. For example, Patent Document 1 discloses a system for taking an image data of a paper-based voucher and performing optical character recognition (OCR) on the image data to determine whether there is an error in the OCR result.

### REFERENCE

### Patent Document

[Patent Document 1] PCT International Publication No. WO2022/101735

### SUMMARY OF THE INVENTION

There is plenty of room for improvement in accounting processing relating to vouchers even when accounting software having the above function is used.

For example, information that is written on a paper-based voucher may not be present in transaction data registered in a database. Such information needs to be newly added to the transaction data. Furthermore, in some cases, both voucher and transaction data may lack information even though the information is necessary for accounting. In such a case, it is necessary to contact a person relating to the ordering destination, the ordering source, accounting, or the like about the lacking information.

In both cases, determination and work by an accountant are necessary, leading to a decrease in work efficiency.

In view of the above, an object of one embodiment of the present invention is to provide a system, software, an information processing device, or an accounting processing method that can increase the efficiency of accounting processing relating to a voucher. Another object of one embodiment of the present invention is to provide a system, software, an information processing device, or an accounting processing method that can increase the efficiency of linking a paper-based voucher and transaction data registered in a database. Another object of one embodiment of the present invention is to provide a system, software, an information processing device, or an accounting processing method that can increase the efficiency of registering information written on a paper-based voucher in a database. Another object of one embodiment of the present invention is to provide a system, software, an information processing device, or an accounting processing method that can support addition of information necessary for accounting.

Note that the description of these objects does not preclude the existence of other objects. One embodiment of the present invention does not need to achieve all these objects. Other objects will be apparent from and can be derived from the description of the specification, the drawings, the claims, and the like.

One embodiment of the present invention is an accounting system including a reception unit, a first processing unit, a database, and a second processing unit. The reception unit has a function of receiving voucher data and a function of receiving approval or disapproval of a suggestion presented by the first processing unit; the second processing unit has a function of performing processing using a language model; the first processing unit has a first function and a second function; the first function is a function of obtaining a plurality of pieces of transaction data whose voucher is not registered from the database, creating a first instruction sentence, inputting the first instruction sentence to the second processing unit, obtaining a first output from the second processing unit, showing a suggestion to link the voucher data and the transaction data from the first output in the reception unit, and registering the link approved in the reception unit in the database; the first instruction sentence instructs collation of the plurality of pieces of transaction data with the voucher data to identify transaction data matching with the voucher data; the second function is a function of creating a second instruction sentence, inputting the second instruction sentence to the second processing unit, obtaining a second output from the second processing unit, and registering the additional information from the second output in the transaction data; and the second instruction sentence instructs extraction of additional information included in the voucher data and not included in the transaction data.

In the above, the additional information is preferably one or more selected from a full name, a name, a registration number, a transaction date, a transaction content, an amount, an applicable tax rate, a consumption tax amount, a transfer destination, a transfer fee, and contact information.

In the above, it is preferable that the first processing unit have a third function and the third function be a function of extracting an item not included in a combination of the transaction data and the voucher data the link of which is registered and necessary for accounting as lacking information and showing the lacking information in the reception unit.

In the above, it is preferable that the first processing unit have a fourth function, the fourth function be a function of creating a third instruction sentence, inputting the third instruction sentence to the second processing unit, obtaining a third output from the second processing unit, and showing the third output in the reception unit, and the third instruction sentence instruct collation of the lacking information with the transaction data to generate a text for requesting input to compensate for the lacking information.

Another embodiment of the present invention is an accounting system including a reception unit and a processing unit. The reception unit has a function of receiving voucher data and a function of receiving approval or disapproval of a suggestion presented by the processing unit; the processing unit includes a database holding transaction data and has a first function and a second function; the first function is a function of obtaining a plurality of pieces of transaction data whose voucher is not registered from the database, collating the plurality of pieces of transaction data with the voucher data, identifying transaction data matching with the voucher data, showing a suggestion to link the voucher data and the transaction data in the reception unit, and registering the link approved in the reception unit in the database; and the second function is a function of extracting additional information included in the voucher data and not included in the transaction data to register the additional information in the transaction data.

In the above, the additional information is preferably one or more selected from a full name, a name, a registration number, a transaction date, a transaction content, an amount, an applicable tax rate, a consumption tax amount, a transfer destination, a transfer fee, and contact information.

In the above, it is preferable that the processing unit have a third function and the third function be a function of extracting an item not included in a combination of the transaction data and the voucher data the link of which is registered and necessary for accounting as lacking information and showing the lacking information in the reception unit.

In the above, it is preferable that the processing unit have a fourth function and the fourth function be a function of collating the lacking information with the transaction data, generating a text for requesting input to compensate for the lacking information, and showing the text for requesting input to compensate for the lacking information in the reception unit.

According to one embodiment of the present invention, software that can increase the efficiency of accounting processing relating to a voucher can be provided. Another embodiment of the present invention can provide software that can increase the efficiency of linking a paper-based voucher and transaction data registered in a database. Another embodiment of the present invention can provide software that can increase the efficiency of registering information written on a paper-based voucher in a database. Another embodiment of the present invention can provide software that can support addition of information necessary for accounting.

Note that the effects of one embodiment of the present invention are not limited to the effects listed above. The effects listed above do not preclude the existence of other effects. The other effects are effects that are not described in this section and are described below. The other effects will be apparent from and can be derived from the description of the specification, the drawings, and the like by those skilled in the art. One embodiment of the present invention is to have at least one of the aforementioned effects and the other effects. Therefore, one embodiment of the present invention does not have the effects described above in some cases.

### BRIEF DESCRIPTION OF THE DRAWINGS

In the accompanying drawings:

FIG. 1A is a diagram illustrating an example of an accounting system of one embodiment of the present invention, and FIG. 1B is a diagram illustrating an example of a first processing unit of one embodiment of the present invention;

FIG. 2 is a flow chart showing an example of a processing method of an accounting system of one embodiment of the present invention;

FIG. 3 is a flow chart showing an example of a processing method of an accounting system of one embodiment of the present invention;

FIG. 4 is a flow chart showing an example of a processing method of an accounting system of one embodiment of the present invention;

FIG. 5 is a flow chart showing an example of a processing method of an accounting system of one embodiment of the present invention;

FIG. 6A is a diagram illustrating an example of an accounting system of one embodiment of the present invention, and FIG. 6B is a diagram illustrating an example of a processing unit of one embodiment of the present invention;

FIG. 7 is a flow chart showing an example of a processing method of an accounting system of one embodiment of the present invention; and

FIG. 8 is a flow chart showing an example of a processing method of an accounting system of one embodiment of the present invention.

### DETAILED DESCRIPTION OF THE INVENTION

Embodiments will be described in detail with reference to the drawings. Note that the present invention is not limited to the following description and it will be readily appreciated by those skilled in the art that modes and details can be modified in various ways without departing from the spirit and the scope of the present invention. Therefore, the present invention should not be construed as being limited to the description in the following embodiments.

Note that in the structures of the invention described below, the same portions or portions having similar functions are denoted by the same reference numerals in different drawings, and description of such portions is not repeated. The same hatching pattern is used for portions having similar functions, and the portions are not denoted by specific reference numerals in some cases.

The position, size, range, or the like of each component illustrated in drawings does not represent the actual position, size, range, or the like in some cases for easy understanding. Therefore, the disclosed invention is not necessarily limited to the position, size, range, or the like disclosed in the drawings.

Note that in this specification, ordinal numbers such as first, second, and third are used in order to avoid confusion among components, and the terms do not limit the components numerically.

In this specification and the like, character string information written on a voucher is simply referred to as a voucher in some cases. In other words, the simple term “voucher” refers to character string information written on a voucher in some cases.

### Embodiment 1

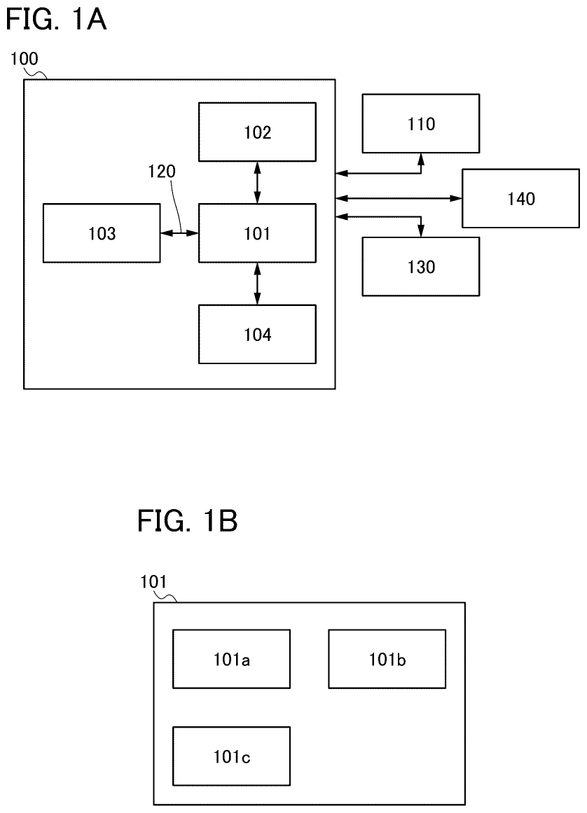

In this embodiment, an accounting system of one embodiment of the present invention will be described with reference to FIGS. 1A and 1B, FIG. 2, FIG. 3, FIG. 4, and FIG. 5.

### <Accounting System>

First, a structure and functions of the accounting system of one embodiment of the present invention will be described with reference to FIGS. 1A and 1B. The accounting system of one embodiment of the present invention is a system for collating a plurality of pieces of transaction data with voucher data, identifying transaction data matching with the voucher data, linking the identified transaction data and the voucher data, and extracting and registering additional information included in the voucher data and not included in the transaction data.

The accounting system includes at least a processing unit. FIG. 1A illustrates a structure of an accounting system 100. The accounting system 100 includes a first processing unit 101, a second processing unit 102, a reception unit 103, and a database 104. Although the block diagram in drawings attached to this specification illustrates components classified by their functions in independent blocks, it is difficult to classify actual components by their functions completely, and one component can have a plurality of functions. Moreover, one function can relate to a plurality of components; for example, processing of the first processing unit 101 or the second processing unit 102 can be executed on a different server depending on processing.

The accounting system 100 can be provided in an information processing device such as a computer used by a user. Alternatively, the first processing unit 101, the second processing unit 102, the database 104, and the like can be provided in a server and used via a network 120 from a client PC functioning as the reception unit 103.

The reception unit 103 has a function of receiving data. Examples of the data include voucher data, accounting data including transaction data, and text data. The reception unit 103 has a function of receiving at least the voucher data. The reception unit 103 has a function of receiving the user's approval or disapproval of the suggestion presented by the first processing unit 101. Furthermore, the reception unit 103 has a function of receiving the user's confirmation of a content presented by the first processing unit 101. As the reception unit 103, a communication port or an input device such as a computer having a communication function, a display screen, and an input device may be used, for example.

In this embodiment, the voucher data is image data of a voucher or character data (also referred to as character string data) extracted from the voucher using optical character recognition (OCR). The voucher data may include an error in writing or the like derived from the OCR reading error. In addition, there may be an orthographic variation between the voucher data and transaction data each of which has the same content. In this specification and the like, an orthographic variation refers to a state where expressions of words having the same meaning or content are mixed. Examples include the case where a character type such as a hiragana (Japanese character mainly used for native Japanese words), a katakana (Japanese character mainly used for non-native Japanese words), and a kanji (Chinese character) are mixed, the case where character forms of kanji such as an old character form and a new character form are mixed, the case where different okuriganas (declensional kana endings) are mixed, and the case where an abbreviation and an official name are mixed.

The transaction data is information such as a full name, a name, a registration number, a transaction date, a transaction content, an amount, an applicable tax rate, a consumption tax amount, a transfer destination, a transfer fee, and contact information. The above consumption tax can be replaced with a value-added tax, a sales tax, an excise tax, a price-increase tax, a business tax, or the like. Furthermore, information such as a registration source, transaction means, an overview, an account title, or a subsidiary account title is added in some cases.

The transaction data and voucher data are each preferably included in a format that can be expressed as a character string, such as a CSV format, a TSV format, a JSON format, or an HTML format.

For example, the reception unit 103 has a function of receiving the voucher data. Alternatively, the reception unit 103 has a function of receiving the image data of the voucher. Alternatively, the reception unit 103 has a function of receiving character data extracted from the voucher.

The database 104 has a function of registering the accounting data including the transaction data. The database 104 has a function of registering the voucher data. Furthermore, the database 104 has a function of registering a link between a certain transaction data and a certain voucher data. Transaction data sometimes lack information necessary for accounting for various reasons such as being in a state before completion of a transaction or an input error.

The second processing unit 102 has a function of performing processing using a language model. The language model can also be referred to as a large language model (LLM), a text generative model, a conversational model, or the like. A large language model is a natural language processing model in which learning is performed using a massive amount of data. With a large language model, for example, a conversational model that gives an answer to a user's instruction can be achieved. For example, a large language model such as GPT-3, GPT-3.5, GPT-4 (registered trademark), Language Model for Dialogue Applications (LaMDA), Pathways Language Model (PaLM), or Llama2 can be used.

The first processing unit 101 has a function of obtaining data received by the reception unit 103. The first processing unit 101 has a function of accessing the database 104 to obtain the plurality of pieces of transaction data. The first processing unit 101 has a function of creating an instruction sentence to be input to the second processing unit 102. The first processing unit 101 has a function of inputting the instruction sentence to the second processing unit 102 to obtain an output from the second processing unit 102. Furthermore, the first processing unit 101 has a function of showing information obtained from the output in the reception unit 103. The first processing unit 101 includes at least a first function including a combination of the above-described functions and a second function.

As the first function, the first processing unit 101 has a function of obtaining the plurality of pieces of transaction data whose voucher is not registered from the database 104. All pieces of the transaction data whose voucher is not registered may be obtained, but obtaining some pieces of the transaction data is preferable in terms of processing speed. For example, it is preferable that the transaction data to be obtained be limited by a period in which it was registered. In the case where the transaction data is limited by a condition such as a registered period, the transaction data whose voucher has been registered may also be obtained. In this case, when collating a certain voucher with the transaction data in a subsequent step, if it is found that the voucher is registered in the existing transaction data, the reception unit 103 can show this fact. The condition such as the registered period can be specified in advance by the user.

As the first function, the first processing unit 101 has a function of creating a first instruction sentence. The instruction sentence is also referred to as a prompt. The first instruction sentence preferably includes an instruction for the second processing unit 102 to collate the plurality of pieces of transaction data obtained from the database with the voucher data obtained from the reception unit 103 to identify the transaction data matching with the voucher data. The first instruction sentence preferably includes the plurality of pieces of transaction data obtained from the database and the voucher data in formats that can each be expressed as a character string. When the first instruction sentence includes these pieces of data, the second processing unit 102 can output an answer through natural language processing.

Since the voucher data may include an error in writing, an orthographic variation, or the like, the first instruction sentence preferably includes, in addition to the above, an instruction to report the voucher data not matching with the transaction data when these pieces of data do not completely match each other. Note that in this case, “completely match” refers to a complete match of a content of a certain item included in the transaction data with the voucher data and does not refer to a complete match of all items.

As the first function, the first processing unit 101 has a function of inputting the first instruction sentence to the second processing unit 102.

The second processing unit 102 has a function of generating an answer to an input instruction sentence through processing using the language model to output the answer. With use of a large language model, even when an error in writing, an orthographic variation, or the like derived from a reading error is included, it is possible to output the result of appropriate data collation as an answer while recognizing the error in writing or orthographic variation. Here, the answer to the first instruction sentence is referred to as a first output. The first output preferably includes a combination of the transaction data and voucher data in the case where the transaction data matching with the voucher data can be identified or the fact that the matching transaction data and voucher data cannot be identified. The first output preferably includes a content pointing out an error in writing, an orthographic variation, or the like.

As the first function, the first processing unit 101 has a function of obtaining the first output from the second processing unit 102.

In the case where a combination of the matching voucher data and transaction data is included in the first output, the reception unit 103 has a function of showing a suggestion to link the voucher data and transaction data. When an error in writing, an orthographic variation, or the like is pointed out in the first output, the first processing unit 101 preferably has a function of showing this point also in the reception unit 103.

The user can approve or disapprove the suggestion to link the voucher data and transaction data shown in the reception unit 103.

In addition, the reception unit 103 has a function of receiving the user's approval or disapproval. Furthermore, the reception unit 103 has a function of receiving the user's confirmation of the content presented by the first processing unit 101. The user's approval or disapproval and confirmation can be performed via an input device 130.

As the first function, the first processing unit 101 has a function of registering a link between the voucher data and transaction data for which the approval is received by the reception unit 103 in the database 104.

Furthermore, as the second function, the first processing unit 101 has a function of creating a second instruction sentence. The second instruction sentence preferably includes an instruction to extract additional information included in the voucher data and not included in the transaction data in the combination of the voucher data and transaction data whose link is registered. The additional information is, for example, one or more selected from a full name, a name, a registration number, a transaction date, a transaction content, an amount, an applicable tax rate, a consumption tax amount, a transfer destination, a transfer fee, and contact information. Furthermore, the additional information may be one or more selected from a registration source, transaction means, an overview, a product description, an account title, and a subsidiary account title.

As the second function, the first processing unit 101 has a function of inputting the second instruction sentence to the second processing unit 102.

The second processing unit 102 has a function of generating an answer to the input instruction sentence through processing using the language model to output the answer. Here, the answer to the second instruction sentence is referred to as a second output. When additional information is provided, it is preferably included in the second output.

As the second function, the first processing unit 101 has a function of obtaining the second output from the second processing unit 102.

In the case where the second output includes the additional information, as the second function, the first processing unit 101 has a function of registering the additional information in the transaction data.

Note that the registration of the additional information may be performed after obtaining the user's approval. In the case where the user's approval is obtained, as the second function, the first processing unit 101 preferably has a function of showing a suggestion of the additional information in the reception unit 103 and a function of registering the additional information for which the approval is received by the reception unit 103 in the transaction data.

Furthermore, the first processing unit 101 can have a third function.

As the third function, the first processing unit 101 preferably has a function of extracting an item not included in the combination of the transaction data and voucher data whose link is registered and necessary for accounting as lacking information and showing the lacking information in the reception unit 103. Alternatively, as the third function, the first processing unit 101 preferably has a function of extracting an item not included in the transaction data and necessary for accounting as lacking information and showing the lacking information in the reception unit 103.

Furthermore, the first processing unit 101 can have a fourth function.

As the fourth function, the first processing unit 101 has a function of creating a third instruction sentence. The third instruction sentence preferably includes an instruction to collate the lacking information obtained by the third function with the transaction data to generate a text for requesting input or the like to compensate for the lacking information. Note that in this specification and the like, a “text” refers to what is constituted by one or more “sentences”. Accordingly, a “text” encompasses a “sentence”.

As the fourth function, the first processing unit 101 has a function of inputting the third instruction sentence to the second processing unit 102.

The second processing unit 102 has a function of generating an answer to an input instruction sentence through processing using the language model to output the answer. A natural text can be created using the large language model. Here, the answer to the third instruction sentence is referred to as a third output. In the case where a registration number, for example, is lacking, the third output preferably includes a text requesting to notify the registration number and information such as contact information and a full name that are obtained from the transaction data. In the case where the amounts do not match each other, the third output preferably includes a text requesting to confirm the amounts and information such as contact information and a full name that are obtained from the transaction data.

As the fourth function, the first processing unit 101 has a function of obtaining the third output from the second processing unit 102.

As the fourth function, the first processing unit 101 has a function of showing the third output in the reception unit 103.

The user can request a person involved to add information necessary for accounting using the text of the third output shown in the reception unit 103.

FIG. 1B illustrates a structure of the first processing unit 101. As illustrated in FIG. 1B, the first processing unit 101 preferably includes a data processing unit 101a, an instruction sentence processing unit 101b, and a display processing unit 101c.

The data processing unit 101a has a function of accessing the database 104 to obtain data from and registering data in the database 104.

The instruction sentence processing unit 101b has a function of creating an instruction sentence to be input to the second processing unit 102. Furthermore, the instruction sentence processing unit 101b has a function of obtaining an output from the second processing unit 102 to generate or extract data. For example, the instruction sentence processing unit 101b has a function of creating data related to display created in the display processing unit 101c, extracting data to be registered in the database 104, or the like.

The display processing unit 101c has a function of creating a display content to be shown in the reception unit 103 and a function of obtaining a content received by the reception unit 103.

Although the portions of the first processing unit 101 illustrated in FIG. 1B are classified according to the functions of the first processing unit 101 and independent of each other, some or all of the functions of the first processing unit 101 are not necessarily independent. The structure of the processing unit of one embodiment of the present invention is not limited to the structure of the first processing unit 101 illustrated in FIG. 1B.

The network 120 illustrated in FIG. 1A is a computer network such as the Internet, which is the infrastructure of the World Wide Web (WWW), an intranet, an extranet, a personal area network (PAN), a local area network (LAN), a campus area network (CAN), a metropolitan area network (MAN), a wide area network (WAN), or a global area network (GAN). Note that the network 120 includes wired or wireless communication. Furthermore, the network 120 includes a bus such as a Universal Serial Bus (USB) and near field communication such as Bluetooth (registered trademark).

The input device 130 has a function of reading a paper-based document or the like and generating electronic data of the document. An image scanner, a digital camera, or the like can be used as the input device 130, for example. The document in this embodiment is a voucher, for example.

An optical character reading device 110 has a function of extracting a character string (an imaged character string) included in an image as text data from image data by OCR. A voucher file including text data can be generated from a paper-based voucher using a combination of an image scanner used as the input device 130 and the optical character reading device 110, for example.

The input device 130 may be a device for inputting data. As the input device 130, a keyboard, a pointing device, or a touch panel can be used, for example. The user can input accounting data or the like with the input device 130.

An output device 140 has a function of outputting data output from the first processing unit 101. As the output device 140, a display, a projector, a printer, an audio output device, or a memory can be used, for example.

The above is the description of the structure and functions of the accounting system 100. With the structure and functions, a system can be provided for collating a plurality of pieces of transaction data with voucher data, identifying transaction data matching with the voucher data, linking the identified transaction data and the voucher data, and extracting and registering additional information included in the voucher data and not included in the transaction data.

### <Accounting Processing Method>

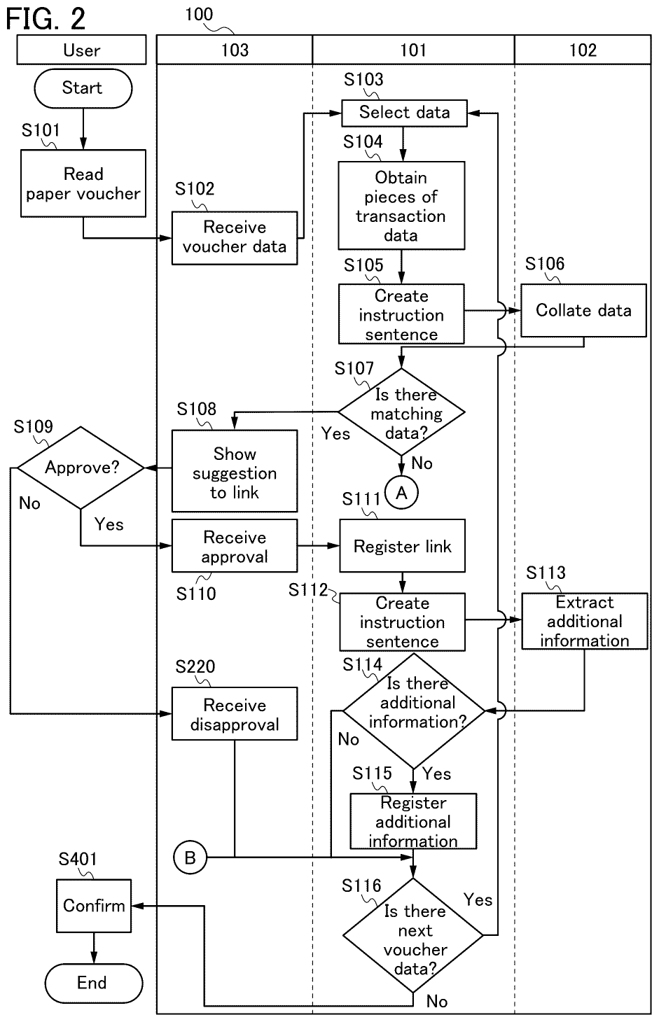

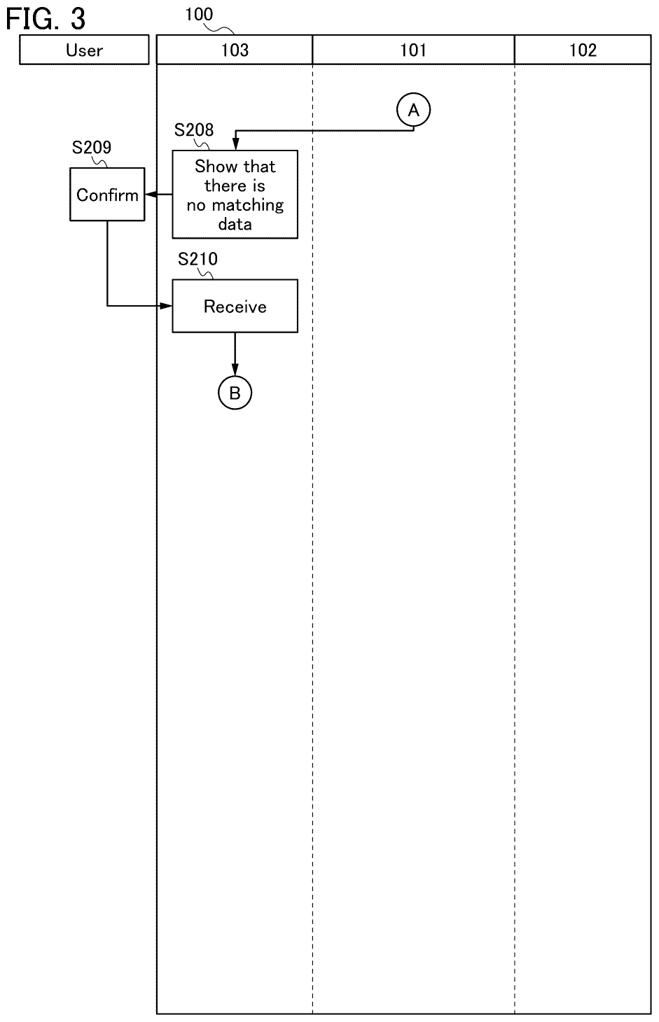

Next, an example of an accounting processing method using the accounting system 100 of one embodiment of the present invention will be described with reference to flow charts in FIGS. 2 and 3. FIGS. 2, 3, 4, and 5 are flowcharts each showing a procedure of processing executed by the accounting system of one embodiment of the present invention.

In the accounting processing method shown in FIGS. 2 and 3, a paper-based voucher is prepared before the processing starts. Although the processing can be implemented with only one voucher, a plurality of vouchers are preferably used because the efficiency of accounting processing can be improved.

In addition, the plurality of pieces of transaction data registered in the database 104 are prepared.

The accounting processing method shown in FIGS. 2 and 3 includes at least Steps S101 to S116, Steps S209 to S210, Step S220, and Step S401.

Step S101 shown in FIG. 2 is a step in which the user performs reading of the paper-based voucher. For example, the paper-based voucher is read using the input device 130 such as an image scanner and the optical character reading device 110, so that the voucher data in a format that can be expressed as a character string can be generated. Alternatively, the voucher data may be input using a keyboard as the input device 130.

Step S102 is a step in which the reception unit 103 receives the voucher data. In the case where there is a plurality of pieces of voucher data, all pieces of the voucher data are received.

Step S103 is a step in which the first processing unit 101 selects the voucher data to be collated. In the case where there are a plurality of pieces of received voucher data, one unprocessed piece thereof is selected.

Step S104 is a step in which the first processing unit 101 obtains the plurality of pieces of transaction data whose voucher is not registered from the database 104. All pieces of the transaction data whose voucher is not registered may be obtained, but obtaining some pieces of the transaction data is preferable in terms of processing speed. For example, it is preferable that the transaction data to be obtained is limited by a period in which it was registered. In the case where the transaction data is limited by a condition such as a registered period, the transaction data whose voucher has been registered may also be obtained.

Step S105 is a step in which the first processing unit 101 generates and inputs the first instruction sentence to the second processing unit 102. The first instruction sentence preferably includes an instruction for the second processing unit 102 to collate the plurality of pieces of transaction data obtained from the database with the voucher data received by the reception unit 103 to identify the transaction data matching with the voucher data. The first instruction sentence preferably includes the plurality of pieces of transaction data obtained from the database and the voucher data in formats that can each be expressed as a character string. When the first instruction sentence includes these pieces of data, the second processing unit 102 can output an answer using only natural language processing. Furthermore, since the voucher data may include an error in writing, an orthographic variation, or the like, the first instruction sentence preferably includes an instruction to report in the case where the voucher data is not completely matching with the transaction data.

Step S106 is a step in which the second processing unit 102 performs the first output, which is the answer to the input first instruction sentence. With use of the large language model, even when an error in writing, an orthographic variation, or the like derived from a reading error is included, it is possible to output the result of appropriate data collation as an answer while recognizing the error in writing or orthographic variation. In other words, Step S106 can be regarded as a step of collating data. The first output preferably includes a combination of the transaction data and voucher data in the case where the transaction data matching with the voucher data can be identified or the fact that the matching transaction data and voucher data cannot be identified. The first output preferably includes a content pointing out an error in writing, an orthographic variation, or the like.

Step S107 is a step in which the first processing unit 101 obtains the first output from the second processing unit 102 to determine whether the transaction data matching with the voucher data can be identified. In the case where the first processing unit 101 determines that the transaction data matching with the voucher data can be identified (Yes), the process proceeds to Step S108. In the case where the first processing unit 101 determines that the transaction data matching with the voucher data cannot be identified (No), the processing proceeds to Step S208 in FIG. 3 as indicated by a connector A.

Step S108 shown in FIG. 2 is a step in which the reception unit 103 shows a suggestion to link the transaction data and voucher data determined to match each other in Step S107. Note that as an example of a method for showing the suggestion, display content created by the display processing unit 101c can be displayed on a display screen of the reception unit 103. When an error in writing, an orthographic variation, or the like is pointed out in the first output, this is also preferably shown in the reception unit 103.

Step S109 is a step in which the user approves or disapproves the suggestion to link the voucher data and transaction data shown in the reception unit 103. In the case of approval (Yes), the process proceeds to Step S110. In the case of disapproval (No), the process proceeds to Step S220.

Step S110 is a step in which the reception unit 103 receives the user's approval.

Step S111 is a step in which the first processing unit 101 registers the link between the voucher data and transaction data for which the approval is received by the reception unit 103 in the database 104.

Step S112 is a step in which the first processing unit 101 generates and inputs the second instruction sentence to the second processing unit 102. The second instruction sentence preferably includes an instruction to extract additional information included in the voucher data and not included in the transaction data in the combination of the voucher data and transaction data whose link is registered. The additional information is, for example, one or more selected from a full name, a name, a registration number, a transaction date, a transaction content, an amount, an applicable tax rate, a consumption tax amount, a transfer destination, a transfer fee, and contact information. Furthermore, the additional information may be one or more selected from a registration source, transaction means, an overview, a product description, an account title, and a subsidiary account title.

Step S113 is a step in which the second processing unit 102 performs the second output, which is the answer to the input second instruction sentence. When the additional information is provided, it is preferably included in the second output.

Step S114 is a step in which the first processing unit 101 obtains the second output from the second processing unit 102 to determine whether there is additional information in the second output. In the case where the first processing unit 101 determines that there is additional information, the process proceeds to Step S115. In the case where the first processing unit 101 determines that there is no additional information, the process proceeds to Step S116.

Step S115 is a step in which the first processing unit 101 registers the additional information in the transaction data in the database 104. Note that between Steps S114 and S115, a step of receiving the user's approval or disapproval for registration of the additional information may be added.

Step S116 is a step in which the first processing unit 101 determines whether there is voucher data to be processed next; that is, the first processing unit 101 determines whether there is unprocessed voucher data received in Step S102. In the case where the first processing unit 101 determines that there is voucher data to be processed next, the process proceeds to Step S103. In the case where the first processing unit 101 determines that there is no voucher data to be processed next, the process proceeds to Step S401.

Step S220 is a step in which the reception unit 103 receives the user's disapproval.

Step S401 is a step in which the user confirms the end of the accounting processing.

Step S208 shown in FIG. 3 is a step in which the reception unit 103 shows the fact that the transaction data matching with the voucher data is not identified.

Step S209 is a step in which the user confirms the fact that the transaction data matching with the voucher data is not identified.

Step S210 is a step in which the reception unit 103 receives the user's confirmation. After Step S210, the process proceeds to Step S116 in FIG. 2 as shown by a connector B.

Through Steps S103 to S108 and Step S110, the above-described first function of the first processing unit 101 can be achieved. Through Steps S112 to S115, the second function can be achieved.

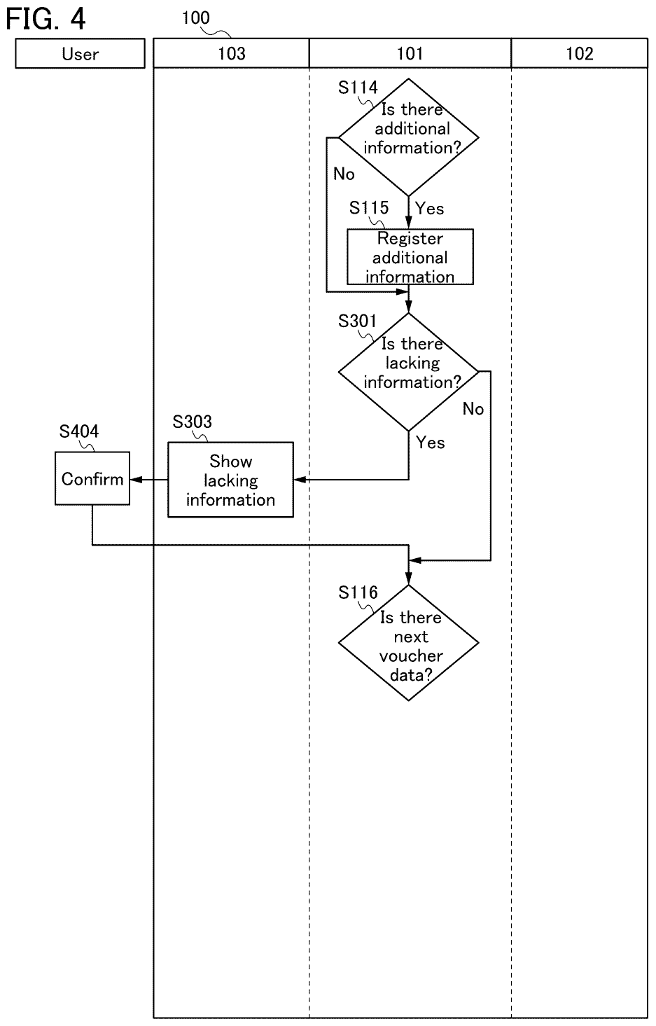

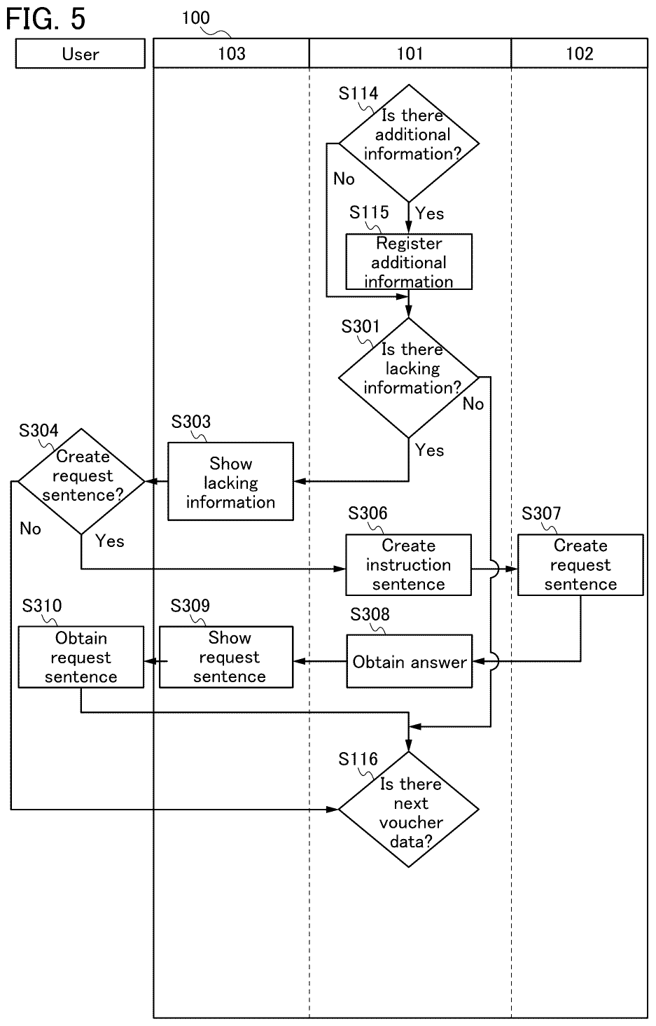

The above is the description of the accounting processing method example. Note that the accounting processing method of one embodiment of the present invention is not limited to the methods described with reference to FIGS. 2 and 3. For example, it is further preferable to employ an accounting processing method in which steps shown in FIG. 4 or 5 are added to the above.

FIG. 4 is a flow chart showing Steps S301 to S404 that are added between Steps S115 and S116 shown in FIG. 2.

Step S301 is a step in which the first processing unit 101 determines whether there is lacking information, that is, an item that is not included in the combination of the transaction data and voucher data whose link is registered and necessary for accounting. In the case where the first processing unit 101 determines that there is lacking information, the process proceeds to Step S303. In the case where the first processing unit 101 determines that there is no lacking information, the process proceeds to Step S116.

Step S303 is a step in which the reception unit 103 shows the lacking information to the user.

Step S404 is a step in which the user confirms the lacking information.

Through Steps S301 and S303, the above-described third function can be achieved.

FIG. 5 is a flow chart showing Steps S301 to S310 that are added between Steps S115 and S116 shown in FIG. 2. For Steps 301 and 303, the description of FIG. 3 can be referred to.

Step S304 is a step in which the user determines whether a text requesting to compensate for the lacking information is created. In the case of creating the text, the process proceeds to Step S306. In the case of not creating the text, the process proceeds to Step S116.

Step S306 is a step in which the first processing unit 101 generates and inputs the third instruction sentence to the second processing unit 102. The third instruction sentence preferably includes an instruction to collate the lacking information obtained by the third function with the transaction data to generate a text for requesting input or the like to compensate for the lacking information.

Step S307 is a step in which the second processing unit 102 performs the third output, which is the answer to the input third instruction sentence. In the case where a registration number, for example, is lacking, the third output preferably includes a text requesting to notify the registration number and contact information, a full name, and the like that are obtained from the transaction data. In the case where the amounts do not match each other, the third output preferably includes a text requesting to confirm the amounts and contact information, a full name, and the like that are obtained from the transaction data.

Step S308 is a step in which the first processing unit 101 obtains the third output.

Step S309 is a step in which the reception unit 103 shows the third output. The user can obtain the text of the third output shown in the reception unit 103 (Step S310) and request a person involved to add information necessary for accounting.

At least part of this embodiment can be implemented as appropriate in combination with any of the other embodiments described in this specification.

### Embodiment 2

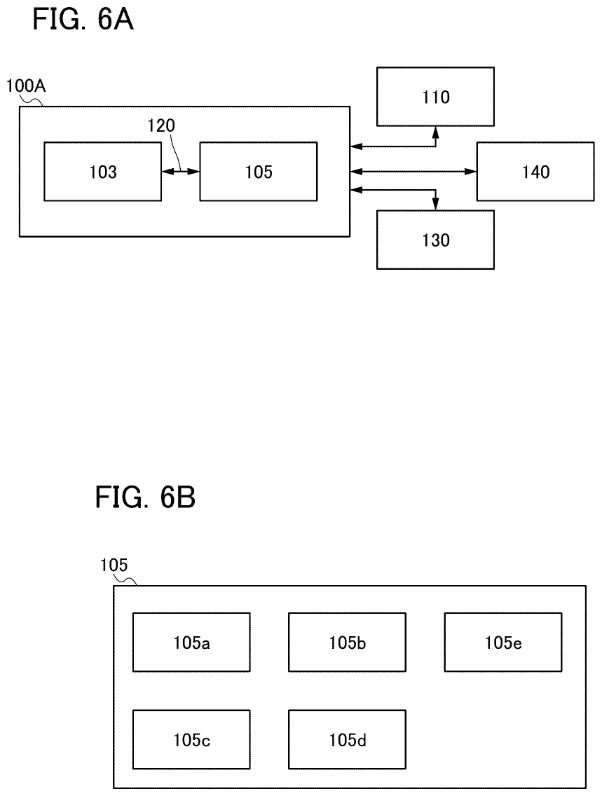

In this embodiment, another example of the accounting system of one embodiment of the present invention will be described with reference to FIGS. 6A and 6B, FIG. 7, and FIG. 8.

### <Another Example of Accounting System>

The accounting system of one embodiment of the present invention is not limited to the structure and functions described in Embodiment 1. For example, the first processing unit 101, the second processing unit 102, and the database 104 are not necessarily separated from each other.

FIG. 6A illustrates a structure of an accounting system 100A including the reception unit 103 and a processing unit 105. The processing unit 105 has functions of the first processing unit 101, the second processing unit 102, and the database 104. Components having the same reference numerals as those in the accounting system 100 have common structures and functions, and the description in Embodiment 1 can be referred to.

The accounting system 100A can access the processing unit 105 via the network 120 from a client PC functioning as the reception unit 103, for example.

FIG. 6B illustrates a structure of the processing unit 105. As illustrated in FIG. 6B, the processing unit 105 preferably includes a data processing unit 105a, an instruction sentence processing unit 105b, a display processing unit 105c, an answer generation unit 105d, and a database 105e.

The data processing unit 105a has a function of accessing the database 105e to obtain data from and registering data in the database 105e.

The instruction sentence processing unit 105b has a function of creating an instruction sentence. Furthermore, the instruction sentence processing unit 105b has a function of creating or extracting data from the output answer.

The display processing unit 105c has a function of creating a display content to be shown in the reception unit 103 and a function of obtaining a content received by the reception unit 103.

The answer generation unit 105d has a function of performing processing using the language model. The description of the second processing unit 102 in the above embodiment can be referred to.

The database 105e has a function of registering the accounting data including the transaction data. The database 105e has a function of registering the voucher data. The description of the database 104 in the above embodiment can be referred to.

As the first function, the processing unit 105 has a function of obtaining the plurality of pieces of transaction data whose voucher is not registered from the database 105e. All pieces of the transaction data whose voucher is not registered may be obtained, but obtaining some pieces of the transaction data is preferable in terms of processing speed. For example, it is preferable that the transaction data to be obtained be limited by a period in which it was registered. In the case where the transaction data is limited by a condition such as a registered period, the transaction data whose voucher has been registered may also be obtained. In this case, when collating a certain voucher with the transaction data, if it is found that the voucher is registered in the existing transaction data, the reception unit 103 can show this fact.

The processing unit 105 has a function of collating the plurality of pieces of transaction data obtained from the database with the voucher data obtained from the reception unit 103 to identify the transaction data matching with the voucher data. The processing unit 105 preferably has a function of pointing out an error in writing, an orthographic variation, or the like.

For example, with use of the large language model, even when an error in writing, an orthographic variation, or the like derived from a reading error is included, appropriate data collation can be performed while recognizing the error in writing or orthographic variation.

As the first function, the processing unit 105 has a function of registering a link between the voucher data and transaction data for which the approval is received by the reception unit 103 in the database 105e.

In the case where the additional information is provided, as the second function, the processing unit 105 has a function of extracting the additional information. In the case where additional information is provided, as the second function, the processing unit 105 has a function of registering the additional information in the transaction data.

Note that the registration of the additional information may be performed after obtaining the user's approval. In the case where the user's approval is obtained, as the second function, the processing unit 105 preferably has a function of showing a suggestion of the additional information in the reception unit 103 and a function of registering the additional information for which the approval is received by the reception unit 103 in the transaction data.

Furthermore, the processing unit 105 can have the third function. As the third function, the processing unit 105 preferably has a function of extracting an item not included in the combination of the transaction data and voucher data whose link is registered and necessary for accounting as lacking information and showing the lacking information in the reception unit 103. Alternatively, as the third function, the processing unit 105 preferably has a function of extracting an item not included in the transaction data and necessary for accounting as lacking information and showing the lacking information in the reception unit 103.

Furthermore, the processing unit 105 can have the fourth function. As the fourth function, the processing unit 105 preferably has a function of collating the lacking information obtained by the third function with the transaction data, generating a text to request input or the like to compensate for the lacking information, and showing the text in the reception unit 103.

### <Another Example of Accounting Processing Method>

Next, an example of an accounting processing method using the accounting system 100A of one embodiment of the present invention will be described with reference to flow charts in FIGS. 3, 7 and 8. FIGS. 3, 7, and 8 are flowcharts each showing a procedure of processing executed by the accounting system of one embodiment of the present invention.

In this embodiment, steps different from those in the accounting processing method described in Embodiment 1 are mainly described. Note that the description in Embodiment 1 can be referred to for the same step.

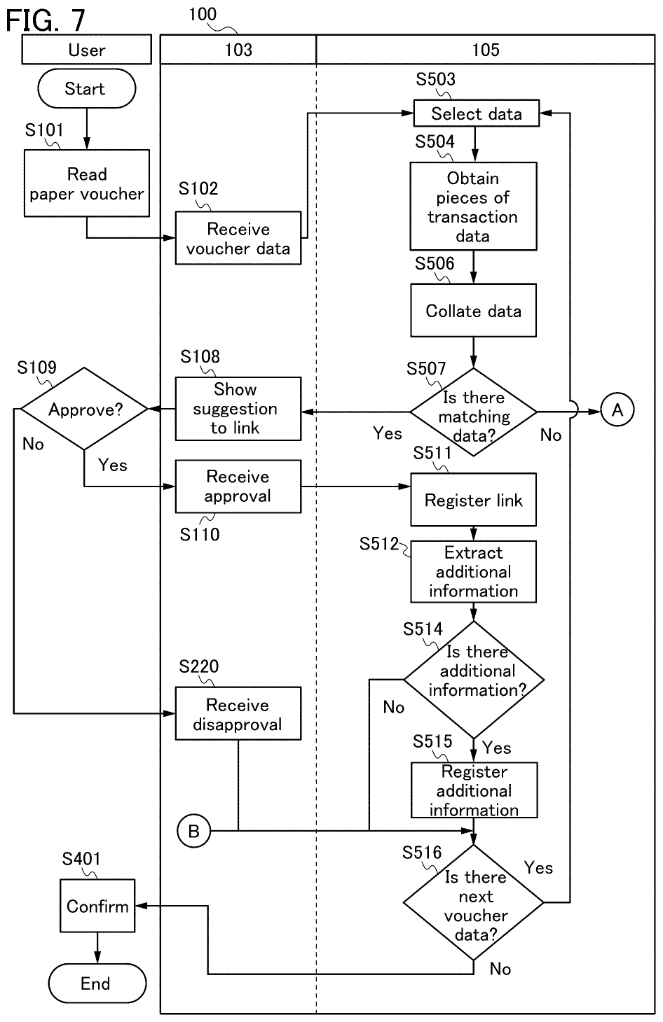

The accounting processing method shown in FIG. 7 includes Steps S503 to S507, Step S511, Step S512, and Steps S514 to S516, which is different from that in Embodiment 1. The accounting processing method shown in FIG. 7 is different from that described in Embodiment 1 in that Steps S503 to S508 are included instead of Steps S103 to S108 and Steps S510 to S516 are included instead of Steps S110 to S116.

Step S503 shown in FIG. 7 is a step in which the processing unit 105 selects the voucher data to be collated. In the case where there are a plurality of pieces of received voucher data, one unprocessed piece thereof is selected.

Step S504 is a step in which the processing unit 105 obtains the plurality of pieces of transaction data whose voucher is not registered from the database 105e. For the details of Step S504, the description of Step S104 can be referred to.

Step S506 is a step in which the processing unit 105 obtains the plurality of pieces of transaction data whose voucher is not registered from the database 105e, collates the plurality of pieces of transaction data with the voucher data obtained from the reception unit 103, and identifies the transaction data matching with the voucher data. In this case, collation is preferably performed using the large language model. With use of the large language model, even when an error in writing, an orthographic variation, or the like derived from a reading error is included, appropriate data collation can be performed while recognizing the error in writing or orthographic variation. The processing unit 105 preferably points out an error in writing, an orthographic variation, or the like.

Step S507 is a step in which the processing unit 105 determines whether the transaction data matching with the voucher data can be identified as a result of the collation. In the case where the processing unit 105 determines that the matching data can be identified, the process proceeds to Step S108. In the case where the processing unit 105 determines that the matching data cannot be identified, the processing proceeds to Step S208 in FIG. 3 as shown by the connector A.

Step S511 is a step in which the processing unit 105 registers the link between the voucher data and transaction data for which the approval is received by the reception unit 103 in the database 105e.

Step S512 is a step in which the processing unit 105 extracts the additional information included in the voucher data and not included in the transaction data in the combination of the voucher data and transaction data whose link is registered. For the details of the additional information, the description of Step S112 can be referred to.

Step S514 is a step in which the processing unit 105 determines whether there is additional information. In the case where the processing unit 105 determines that there is additional information, the process proceeds to Step S514. In the case where the processing unit 105 determines that there is no additional information, the process proceeds to Step S516.

Step S515 is a step in which the processing unit 105 registers the additional information in the transaction data in the database 105e.

Step S516 is a step in which the processing unit 105 determines whether there is voucher data to be processed next. In the case where the processing unit 105 determines that there is voucher data to be processed next, the process proceeds to Step S503. In the case where the processing unit 105 determines that there is no voucher data to be processed next, the process proceeds to Step S401.

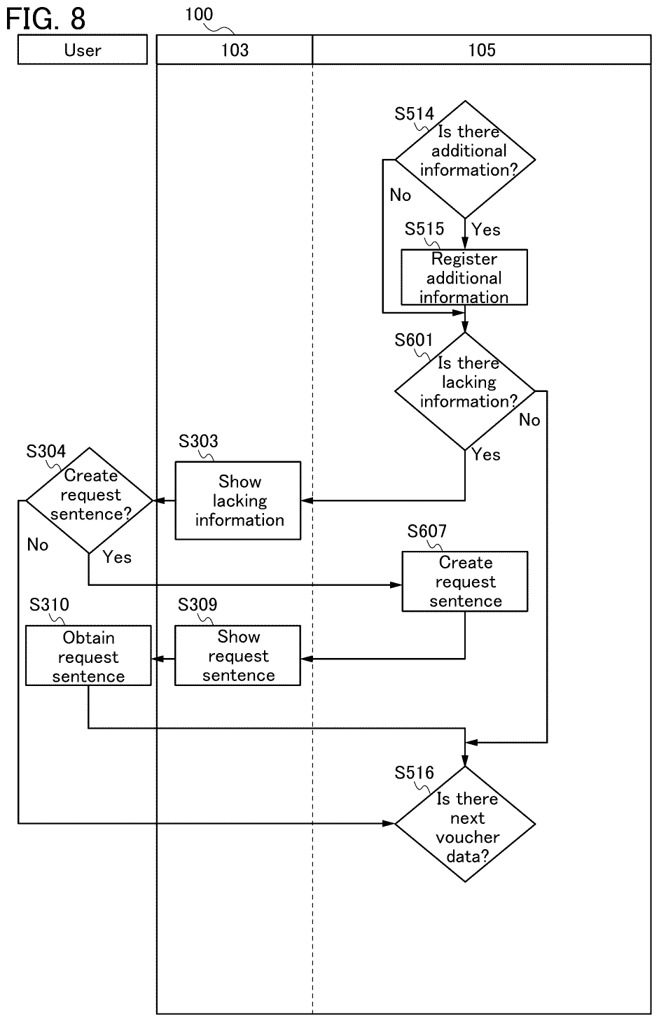

The above is the description of another example of the accounting processing method. Note that the accounting processing method of one embodiment of the present invention is not limited to the above, and an accounting processing method in which steps shown in FIG. 8 are added may be performed, for example.

FIG. 8 is a flow chart showing Steps S601, S303, S304, S607, S309, and S310 that are added between Steps S515 and S516 shown in FIG. 7.

Step S601 is a step in which the processing unit 105 determines whether there is lacking information, that is, an item that is not included in the combination of the transaction data and voucher data whose link is registered and necessary for accounting. In the case where the processing unit 105 determines that there is lacking information, the process proceeds to Step S303. In the case where the processing unit 105 determines that there is no lacking information, the process proceeds to Step S516.

Step S607 is a step in which the processing unit 105 collates the lacking information with the transaction data to generate a text for requesting input or the like to compensate for the lacking information. In this case, collation is preferably performed using the large language model. A natural text can be created using the large language model.

For Steps S309 and S310, the description in Embodiment 1 can be referred to.

At least part of this embodiment can be implemented as appropriate in combination with any of the other embodiments described in this specification.

### Embodiment 3

In this embodiment, hardware that can be used for the accounting system of one embodiment of the present invention will be described in detail.

### [First Processing Unit 101]

The first processing unit 101 has a function of performing processing using data supplied from the reception unit 103, the second processing unit 102, the database 104, or the like. The first processing unit 101 can supply the processing result to the reception unit 103, the second processing unit 102, the database 104, or the like.

A transistor including a metal oxide in a channel formation region may be used in the first processing unit 101. With the use of the transistor having an extremely low off-state current as a switch for retaining electric charge (data) which flows into a capacitor serving as a memory element, a long data retention period can be ensured. When at least one of a register and a cache memory included in the first processing unit 101 has such a feature, the first processing unit 101 can be operated only when needed, and otherwise can be off while information processed immediately before turning off the first processing unit 101 is stored in the memory element. In other words, normally-off computing is possible, and power consumption of the accounting system can be reduced.

In this specification and the like, a transistor including an oxide semiconductor in a channel formation region is referred to as an oxide semiconductor transistor (OS transistor). A channel formation region of an OS transistor preferably includes a metal oxide.

The metal oxide included in the channel formation region preferably contains indium (In). When the metal oxide included in the channel formation region is a metal oxide containing indium, the carrier mobility (electron mobility) of the OS transistor is high. The metal oxide included in the channel formation region preferably contains an element M. The element M is preferably aluminum (Al), gallium (Ga), or tin (Sn). Other elements that can be used as the element M are boron (B), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high bonding energy with oxygen. The element M is, for example, an element that has higher bonding energy with oxygen than indium does. The metal oxide in the channel formation region preferably contains zinc (Zn). The metal oxide containing zinc is easily crystallized in some cases.

The metal oxide included in the channel formation region is not limited to the metal oxide containing indium. The metal oxide included in the channel formation region may be, for example, a metal oxide that does not contain indium and contains any of zinc, gallium, and tin (e.g., zinc tin oxide or gallium tin oxide).

Furthermore, a transistor including silicon in a channel formation region may be used in the first processing unit 101.

In the first processing unit 101, a transistor including an oxide semiconductor in a channel formation region and a transistor including silicon in a channel formation region may be used in combination.

The first processing unit 101 includes, for example, an arithmetic circuit, a central processing unit (CPU), or the like.

The first processing unit 101 may include a microprocessor such as a digital signal processor (DSP) or a graphics processing unit (GPU). The microprocessor may be configured with a programmable logic device (PLD) such as a field programmable gate array (FPGA) or a field programmable analog array (FPAA). The first processing unit 101 can interpret and execute instructions from programs with use of a processor to process various kinds of data and control programs. The programs to be executed by the processor are stored in at least one of the second processing unit 102 and a memory region of the processor.

The first processing unit 101 may include a main memory. The main memory includes at least one of a volatile memory such as a random access memory (RAM) and a nonvolatile memory such as a read only memory (ROM).

For example, a dynamic random access memory (DRAM) or a static random access memory (SRAM) is used as the RAM, in which case a virtual memory space is assigned to the RAM to be used as a work space for the first processing unit 101.

The ROM can store a basic input/output system (BIOS), firmware, and the like for which rewriting is not needed. Examples of the ROM include a mask ROM, a one-time programmable read only memory (OTPROM), and an erasable programmable read only memory (EPROM). Examples of the EPROM include an ultra-violet erasable programmable read only memory (UV-EPROM) which can erase stored data by irradiation with ultraviolet rays, an electrically erasable programmable read only memory (EEPROM), and a flash memory.

[Second processing unit 102]

The second processing unit 102 has a function of performing processing using the large language model. Thus, the second processing unit 102 has a function of storing the large language model. The second processing unit 102 preferably has higher processing power than the first processing unit 101. The second processing unit 102 includes an arithmetic circuit or a CPU, for example. The second processing unit 102 may include a microprocessor such as a DSP or a GPU.

The second processing unit 102 includes at least one of a volatile memory and a nonvolatile memory. For example, the second processing unit 102 may include a volatile memory such as a DRAM or an SRAM. For example, the second processing unit 102 may include a nonvolatile memory such as a resistive random access memory (ReRAM), a phase change random access memory (PRAM), a ferroelectric random access memory (FeRAM), or a magnetoresistive random access memory (MRAM), or a flash memory. In some cases, the second processing unit 102 may include a storage media drive such as a hard disk drive (HDD) or a solid state drive (SSD).

The second processing unit 102 can include the transistor including a metal oxide in a channel formation region described in the section of the first processing unit 101. Since the OS transistor has an extremely low off-state current, a memory including the transistor can be suitably used as a nonvolatile memory for retaining analog data. When weighted data in a neural network is held in an analog memory, a plurality of product-sum operations can be executed in parallel using an analog arithmetic circuit. Thus, when the analog memory including the transistor including a metal oxide is used for the second processing unit 102, power consumption in processing using the large language model can be significantly reduced.

### [Database 104]

The database 104 has a function of registering the accounting data including the plurality of pieces of transaction data. The database 104 includes at least one of a volatile memory and a nonvolatile memory described in the section of the second processing unit 102.

Note that the first processing unit 101, the second processing unit 102, and the database 104 are not necessarily separated from each other. For example, as in the accounting system 100A, the processing unit 105 having functions of the first processing unit 101, the second processing unit 102, and the database 104 may be included.

Note that memories included in the first processing unit 101, the second processing unit 102, and the database 104 can each be regarded as an example of a non-transitory computer-readable storage medium.

### [Network 120]

The network 120 has a function of transmitting various kinds of data. Data can be transmitted and received among the reception unit 103, the optical character reading device 110, the input device 130, the output device 140, the first processing unit 101, the second processing unit 102, the database 104, and the like via the network 120. For example, the voucher data, the transaction data, the input, the output, and the like are transmitted and received via a transmission path.

At least part of this embodiment can be implemented as appropriate in combination with any of the other embodiments described in this specification.

This application is based on Japanese Patent Application Serial No. 2023-211740 filed with Japan Patent Office on Dec. 15, 2023, the entire contents of which are hereby incorporated by reference.

What is claimed is:

1. An accounting system comprising:
a reception unit, a first processing unit, a database, and a second processing unit,
wherein the reception unit is configured to receive voucher data and receive approval or disapproval of a suggestion presented by the first processing unit,
wherein the second processing unit is configured to perform processing using a language model,
wherein the first processing unit is configured to obtain a plurality of pieces of transaction data whose voucher is not registered from the database, create a first instruction sentence, input the first instruction sentence to the second processing unit, obtain a first output from the second processing unit, show a suggestion to link the voucher data and the transaction data from the first output in the reception unit, and register the link approved in the reception unit in the database,
wherein the first instruction sentence instructs collation of the plurality of pieces of transaction data with the voucher data to identify transaction data matching with the voucher data,
wherein the first processing unit is further configured to create a second instruction sentence, input the second instruction sentence to the second processing unit, obtain a second output from the second processing unit, and register the additional information from the second output in the transaction data, and
wherein the second instruction sentence instructs extraction of additional information included in the voucher data and not included in the transaction data.

2. The accounting system according to claim 1,
wherein the additional information is one or more selected from a full name, a name, a registration number, a transaction date, a transaction content, an amount, an applicable tax rate, a consumption tax amount, a transfer destination, a transfer fee, and contact information.

3. The accounting system according to claim 2,
wherein the first processing unit is configured to extract an item not included in a combination of the transaction data and the voucher data the link of which is registered and necessary for accounting as lacking information and show lacking information in the reception unit.

4. The accounting system according to claim 3,
wherein the first processing unit is further configured to create a third instruction sentence, input the third instruction sentence to the second processing unit, obtain a third output from the second processing unit, and show the third output in the reception unit, and
wherein the third instruction sentence instructs collation of the lacking information with the transaction data to generate a text for requesting input to compensate for the lacking information.

5. An accounting system comprising:
a reception unit and a processing unit,
wherein the reception unit is configured to receive voucher data and receive approval or disapproval of a suggestion presented by the processing unit,
wherein the processing unit comprises a database holding transaction,
wherein the processing unit is configured to obtain a plurality of pieces of transaction data whose voucher is not registered from the database, collate the plurality of pieces of transaction data with the voucher data, identify transaction data matching with the voucher data, show a suggestion to link the voucher data and the transaction data in the reception unit, and register the link approved in the reception unit in the database, and
wherein the processing unit is further configured to extract additional information included in the voucher data and not included in the transaction data and register the additional information in the transaction data.

6. The accounting system according to claim 5,
wherein the additional information is one or more selected from a full name, a name, a registration number, a transaction date, a transaction content, an amount, an applicable tax rate, a consumption tax amount, a transfer destination, a transfer fee, and contact information.

7. The accounting system according to claim 6,
wherein the processing unit is configured to extract an item not included in a combination of the transaction data and the voucher data the link of which is registered and necessary for accounting as lacking information and show the lacking information in the reception unit.

8. The accounting system according to claim 7,
wherein the processing unit is further configured to collate the lacking information with the transaction data, generate a text for requesting input to compensate for the lacking information, and show the text for requesting input to compensate for the lacking information in the reception unit.
